(19) United States
(12) Patent Application Publication
(10) Pub. No.: US 2016/0253815 A1
(43) Pub. Date: Sep. 1, 2016

(54) MEASUREMENT APPARATUS

(71) Applicant: CANON KABUSHIKI KAISHA, Tokyo (JP)

(72) Inventor: Takumi Tokimitsu, Utsunomiya-shi (JP)

(21) Appl. No.: 15/053,376

(22) Filed: Feb. 25, 2016

(30) Foreign Application Priority Data
Feb. 27, 2015 (JP) 2015-039319

(51) Int. Cl. G06T 7/00; G01B 11/25; H04N 9/097

(52) U.S. Cl. CPC G06T 7/0073; H04N 9/097; G01B 11/254

(57) ABSTRACT

The present invention provides a measurement apparatus which measures a shape of a target object, the apparatus including a projection unit configured to project, on the target object, line pattern light including a plurality of lines formed from light having a first wavelength and identification pattern light formed from light having a second wavelength different from the first wavelength and including an identification pattern of a plurality of dots for respectively identifying the plurality of lines, and an image sensing unit configured to obtain a first image corresponding to the line pattern light and a second image corresponding to the identification pattern light by separating the line pattern light and the identification pattern light projected on the target object based on wavelengths and sensing the line pattern light and the identification pattern light.

### BACKGROUND OF THE INVENTION

1. Field of the Invention

The present invention relates to a measurement apparatus which measures the shape of a target object.

2. Description of the Related Art

Recently, robots have replaced humans in performing complicated tasks such as assembly processes for industrial products. Robots assemble parts while gripping them with their end effectors such as hands. In order to implement such assembly, it is necessary to measure a three-dimensional shape (position/posture) as the three-dimensional coordinate point group of a part (work) to be gripped.

As a technique of densely measuring the three-dimensional shape of a work, there is known a pattern projection method of projecting a line pattern including a plurality of lines on a work. Consider a case of measuring the three-dimensional shape of a work while relatively moving a measurement apparatus and the work, in order to speed up an assembly process. In this case, it is necessary to perform measurement from one sensed image or a plurality of sensed images obtained at the same time. Techniques related to this operation have been proposed in Japanese Patent No. 2517062, Japanese Patent Laid-Open No. 2013-185832, Japanese Patent No. 4433907, and Japanese Patent No. 5393318.

Japanese Patent No. 2517062 discloses a measurement apparatus which measures the three-dimensional shape of a work by using the pattern projection method. According to Japanese Patent No. 2517062, the three-dimensional shape of a work is obtained from one sensed image by projecting a dot pattern encoded by randomly arranged dots and associating the pattern projected on the work with the sensed image based on the positional relationship between the dots.

In addition, Japanese Patent Laid-Open No. 2013-185832 and Japanese Patent No. 4433907 also disclose measurement apparatuses designed to obtain the three-dimensional shape of a work from one sensed image by using the pattern projection method. According to Japanese Patent Laid-Open No. 2013-185832, the apparatus can obtain the three-dimensional shape of a work from one sensed image by using a pattern including a line pattern and an encode pattern arranged between lines and associating the line pattern from the encode pattern. In addition, according to Japanese Patent No. 4433907, the apparatus can obtain the three-dimensional shape of a work from sensed color images obtained at the same time by using a color line pattern encoded by colors.

Japanese Patent No. 5393318 discloses a technique of measuring the position/posture of a work from the three-dimensional coordinate point group data of the work. According to Japanese Patent No. 5393318, the position/posture of a work is obtained by model fitting using three-dimensional coordinate point group data obtained by the pattern projection method and information (edge data) obtained from a brightness image obtained when the work is uniformly illuminated. According to Japanese Patent No. 5393318, the position/posture of a work is estimated by using maximum likelihood estimation assuming that an error in three-dimensional coordinate group data and an error in edge data respectively comply with different probability distributions. Therefore, even under poor initial conditions, it is possible to stably estimate the position/posture of a work.

According to the technique disclosed in Japanese Patent No. 2517062, however, when a sensed image is degraded by the defocus of a work, a reflectance distribution on the surface of the work, and the like, it is difficult to recognize a dot pattern, that is, an encode pattern.

On the other hand, as disclosed in Japanese Patent Laid-Open No. 2013-185832, even when using a pattern including a line pattern and an encode pattern arranged between lines, it is necessary to consider degradation in a sensed image caused by the defocus of a work and the like. In this case, since the intervals between the lines of the line pattern need to be sufficiently large to allow the recognition of the encode pattern, the density of coordinate points to be measured, that is, the three-dimensional coordinate points of a work. In addition, as disclosed in Japanese Patent No. 4433907, when using a color line pattern encoded by colors, the recognizability of codes is degraded by a reflectance distribution on the surface of a work or its color characteristics.

### SUMMARY OF THE INVENTION

The present invention provides a measurement apparatus advantageous in improving measurement accuracy and robustness in the measurement of the shape of a target object.

According to one aspect of the present invention, there is provided a measurement apparatus which measures a shape of a target object, the apparatus including a projection unit configured to project, on the target object, line pattern light including a plurality of lines formed from light having a first wavelength and identification pattern light formed from light having a second wavelength different from the first wavelength and including an identification pattern of a plurality of dots for respectively identifying the plurality of lines, an image sensing unit configured to obtain a first image corresponding to the line pattern light and a second image corresponding to the identification pattern light by separating the line pattern light and the identification pattern light projected on the target object based on wavelengths and sensing the line pattern light and the identification pattern light, and a processing unit configured to obtain information of a shape of the target object based on the first image and the second image.

Further aspects of the present invention will become apparent from the following description of exemplary embodiments with reference to the attached drawings.

### BRIEF DESCRIPTION OF THE DRAWINGS

FIG. 1 is a schematic view showing the arrangement of a measurement apparatus according to the first embodiment of the present invention.

FIGS. 2A and 2B are views respectively showing parts of the arrangements of first and second masks in the measurement apparatus shown in FIG. 1.

FIGS. 3A and 3B are graphs respectively showing examples of dot profiles in the measurement apparatus shown in FIG. 1 and a conventional measurement apparatus.

FIGS. 4A and 4B are graphs respectively showing examples of dot profiles in the measurement apparatus shown in FIG. 1 and the conventional measurement apparatus.

FIGS. 5A and 5B are graphs respectively showing examples of dot profiles in the measurement apparatus shown in FIG. 1 and the conventional measurement apparatus.

FIG. 6 is a view showing part of the arrangement of the second mask in the measurement apparatus shown in FIG. 1.

FIG. 7 is a view showing part of the arrangement of a mask which can replace the first and second masks shown in FIG. 2.

FIG. 8 is a schematic view showing the arrangement of a measurement apparatus according to the second embodiment of the present invention.

FIG. 9 is a view showing part of the arrangement of a mask in the conventional measurement apparatus.

### DESCRIPTION OF THE EMBODIMENTS

Preferred embodiments of the present invention will be described below with reference to the accompanying drawings. Note that the same reference numerals denote the same members throughout the drawings, and a repetitive description thereof will not be given.

### First Embodiment

FIG. 1 is a schematic view showing the arrangement of a measurement apparatus 1 according to the first embodiment of the present invention. The measurement apparatus 1 is a pattern projection measurement apparatus which measures a three-dimensional shape (position/posture) as the three-dimensional coordinate point group of a target object MT by using the pattern projection method. As shown in FIG. 1, the measurement apparatus 1 includes a projection unit 11, an image sensing unit 12, and a processing unit 13.

The measurement apparatus 1 causes the image sensing unit 12 to obtain an image by sensing an image of a pattern projected on the target object MT by the projection unit 11, and causes the processing unit 13 to obtain the shape of the target object MT based on the sensed image. In this embodiment, line pattern light and encode pattern light are projected on the target object MT. The line pattern light includes a plurality of lines formed by light having the first wavelength. The encode pattern light is formed by light having the second wavelength different from the first wavelength. The line pattern light and the encode pattern light projected on the target object MT are then separated based on the wavelengths to obtain an image corresponding to the line pattern light and an image corresponding to the encode pattern light. This makes it possible to implement a pattern projection measurement apparatus which improves the recognizability of the encode pattern light and is robust with respect to measurement conditions and the target object MT. The specific arrangement of the measurement apparatus 1 and effects obtained by the measurement apparatus 1 (improvements in measurement accuracy and robustness in the measurement of the three-dimensional shape of the target object MT) will be described below.

The projection unit 11 projects line pattern light formed from light having the first wavelength and encode pattern light formed from light having the second wavelength on the target object MT. In this case, the encode pattern light is identification pattern light for identifying each of a plurality of lines included in the line pattern light. The projection unit 11 includes a first light source 111a, a second light source 111b, a first illumination optical system 112a, a second illumination optical system 112b, a first mask 113a, a second mask 113b, a dichroic prism 114, and a projection optical system 115.

The first light source 111a and the second light source 111b respectively emit light beams having different wavelengths. In this embodiment, the first light source 111a emits light having the first wavelength, and the second light source 111b emits light having the second wavelength. The first illumination optical system 112a is an optical system which uniformly illuminates the first mask 113a with light having the first wavelength from the first light source 111a. The second illumination optical system 112b is an optical system which uniformly illuminates the second mask 113b with light having the second wavelength from the second light source 111b. The first illumination optical system 112a and the second illumination optical system 112b are configured to provide Kohler illumination.

The first mask 113a and the second mask 113b each have a transmission portion corresponding to a pattern to be projected on the target object MT, which is formed by, for example, plating a glass substrate with chromium. The dichroic prism 114 is an optical element which combines pattern light beams (light having the first wavelength and light having the second wavelength) transmitted through the first mask 113a (its transmission portion) and the second mask 113b (its transmission portion). The projection optical system 115 is an optical system which forms light having the first wavelength from the first mask 113a and light having the second wavelength from the second mask 113b into images on the target object MT, and projects pattern light beams transmitted through the first and second masks 113a and 113b onto the target object MT.

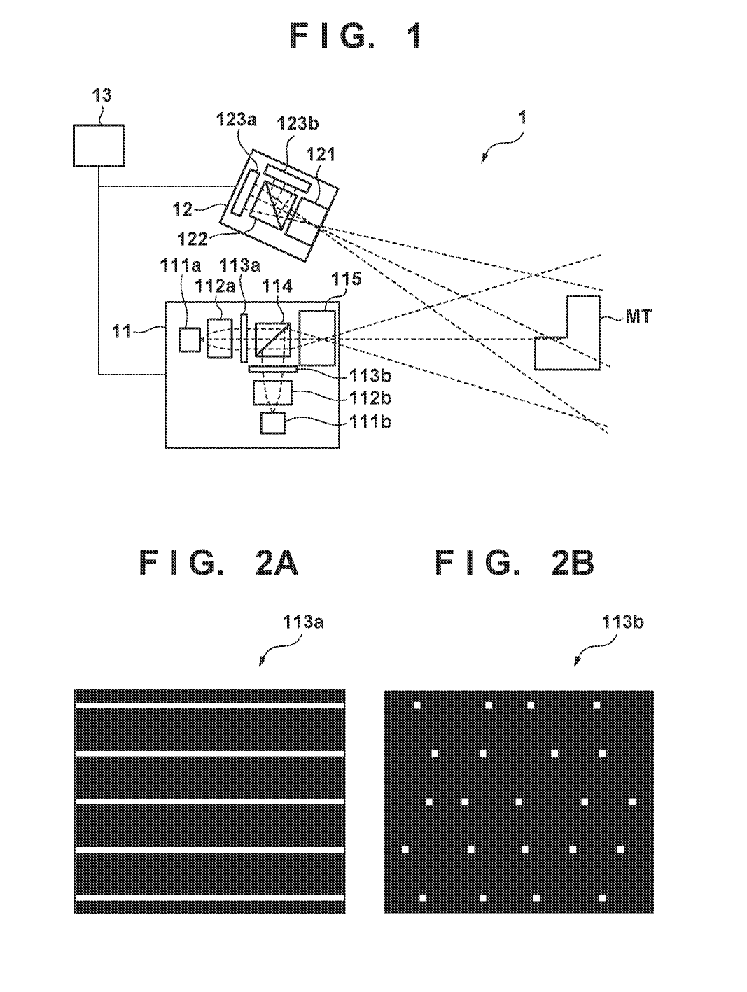

In this embodiment, the first mask 113a generates line pattern light including a plurality of lines, and the second mask 113b generates dot pattern light including a plurality of dots (identification pattern) as encode pattern light. As shown in FIGS. 2A and 2B, the first mask 113a includes a transmission portion which has a shape corresponding to a plurality of lines and transmits light having the first wavelength. The second mask 113b includes a transmission portion which has a shape corresponding to a plurality of dots and transmits light having the second wavelength. Note that dot pattern light functions as a code for associating each line included in line pattern light sensed by the image sensing unit 12 with a specific ordinal number. In this case, FIG. 2A is a view showing part of the arrangement of the first mask 113a. FIG. 2B is a view showing part of the arrangement of the second mask 113b.

Japanese Patent No. 2517062 discloses a mask which generates a dot line pattern, as shown in FIG. 9, as a mask which generates pattern light to be projected on a target object. This embodiment (FIGS. 2A and 2B) differs from Japanese Patent No. 4433907 (FIG. 9) in that a dot line pattern is separated into line pattern light and dot pattern light, and dots included in the dot pattern light are formed from bright portions (bright pattern).

Referring back to FIG. 1, the image sensing unit 12 separates light pattern light and dot pattern light projected on the target object MT based on the wavelengths and performs image sensing for light pattern light and dot pattern light at the same time. The image sensing unit 12 obtains a line pattern image corresponding to line pattern light formed from light having the first wavelength and an encode pattern image corresponding to dot pattern light formed from light having the second wavelength. The image sensing unit 12 includes an imaging optical system 121, a dichroic prism 122, a first image sensor 123a, and a second image sensor 123b.

The imaging optical system 121 is an optical system for forming line pattern light projected on the target object MT into an image on the first image sensor 123a and forming dot pattern light projected on the target object MT into an image on the second image sensor 123b. The dichroic prism 122 is an optical element which separates line pattern light and dot pattern light projected on the target object MT from each other. The first image sensor 123a is an image sensor which senses line pattern light separated by the dichroic prism 122. The second image sensor 123b is an image sensor which senses dot pattern light separated by the dichroic prism 122. The first image sensor 123a and the second image sensor 123b each are formed from a CMOS sensor, CCD sensor, or the like.

As described above, the projection unit 11 has a function of projecting line pattern light and dot pattern light respectively formed from light beams having two different wavelengths on the target object MT. The image sensing unit 12 has a function of separating and sensing line pattern light and dot pattern light projected on the target object MT.

The processing unit 13 obtains information about the shape of the target object MT based on a line pattern light image and an encode pattern image obtained by the image sensing unit 12. The processing unit 13 performs, for example, association of the respective lines included in the line pattern light from the line pattern light image and the encode pattern image, and calculates the three-dimensional coordinate point group data of the target object MT based on the principle of triangulation. The processing unit 13 then calculates the three-dimensional shape of the target object MT by performing model fitting of the three-dimensional coordinate point group data with respect to a CAD model of the target object MT which is registered in advance.

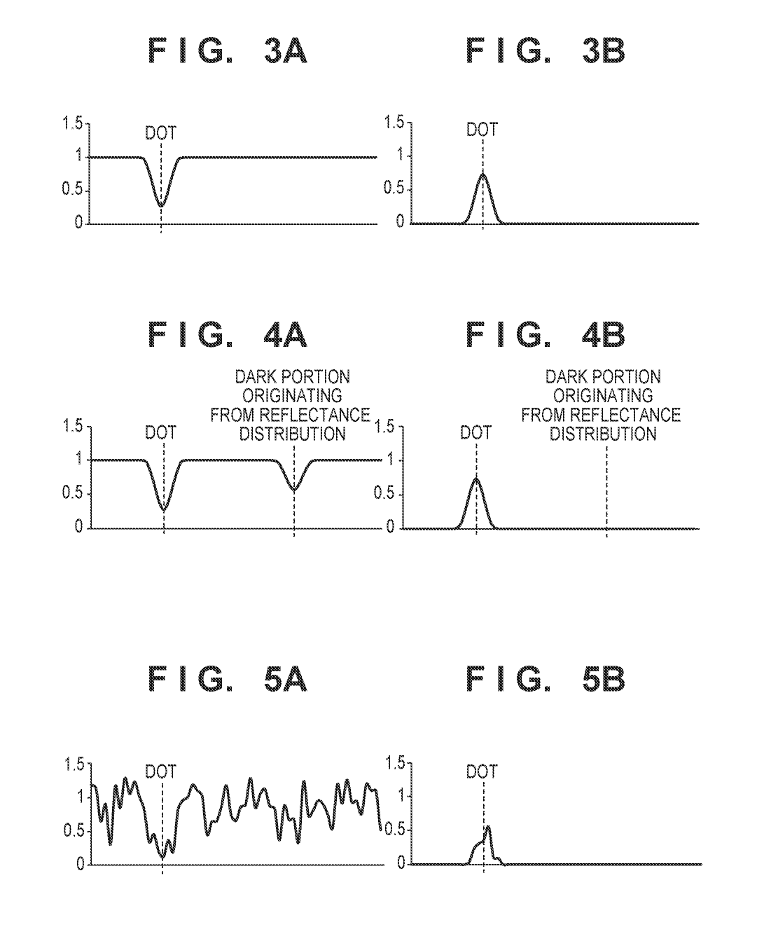

The measurement apparatus 1 according to this embodiment recognizes each dot from an encode pattern image corresponding to dot pattern light, and associates the respective lines in the line pattern image. It is therefore necessary to properly recognize each dot from an encode pattern image. FIG. 3A is a graph showing a dot profile obtained when pattern light generated by the mask shown in FIG. 9 (the mask disclosed in Japanese Patent No. 2517062) is sensed. FIG. 3B is a graph showing a dot profile obtained when dot pattern light generated by the second mask 113b shown in FIG. 2B is sensed. In this case, a dot profile is a sectional profile of an arbitrary dot in a direction along a line of a line pattern image. Referring to each of FIGS. 3A and 3B, the ordinate takes brightness levels, and the abscissa takes positions in a direction along a line.

The dot profiles shown in FIGS. 3A and 3B are those obtained when there is no reflectance distribution on the surface of the target object MT. The dot profile shown in FIG. 3A has a dark portion corresponding to a dot on a line. The dot profile shown in FIG. 3B has a bright portion corresponding to a dot on a line. Although each dot has a rectangular shape on the mask, the obtained profile is similar to a Gaussian distribution because of the influence of blur caused by the optical system. When the dot profiles shown in FIGS. 3A and 3B are obtained, the dot can be properly recognized from the encode pattern image in either case.

The next is a case of having reflectance distribution caused by a defect or the like in the surface of the target object MT. FIG. 4A is a graph showing a dot profile obtained when pattern light generated by the mask shown in FIG. 9 (the mask disclosed in Japanese Patent No. 2517062) is sensed. FIG. 4B is a graph showing a dot profile obtained when pattern light generated by the second mask 113b shown in FIG. 2B is sensed. The dot profiles shown in FIGS. 4A and 4B are those obtained when there is a reflectance distribution on the surface of the target object MT. For the sake of simplicity, assume that the target object MT has only one point at which the reflectance is low.

In the dot profile shown in FIG. 4A, a dark portion is formed originating from the reflectance distribution on the surface of the target object MT, and hence it is difficult to discriminate the dark portion corresponding to the dot from the dark portion originating from the reflectance distribution in the encode pattern image. In this case, erroneously recognizing the dark portion originating from the reflectance distribution as a dot makes it impossible to associate the respective lines in the line pattern image, resulting in a great reduction in measurement accuracy or inability to measure.

On the other hand, in the dot profile shown in FIG. 4B, since the dot is formed from a bright portion, it is possible to properly recognize the dot from the encode pattern image without being influenced by a reflectance distribution on the surface of the target object MT, if any. In addition, even if a dot overlaps a dark portion originating from a reflectance distribution, it is possible to properly recognize the dot from an encode pattern image as long as a dot signal higher than the noise level of the image sensor is obtained.

The next is a case of having a random reflectance distribution on the surface of the target object MT instead of having a low reflectance point at only one portion of the target object MT. FIG. 5A is a graph showing a dot profile obtained when pattern light generated by the mask shown in FIG. 9 (the mask disclosed in Japanese Patent No. 2517062) is sensed. FIG. 5B is a graph showing a dot profile obtained when dot pattern light generated by the second mask 113b shown in FIG. 2B is sensed. The dot profiles shown in FIGS. 5A and 5B each are obtained when there is a random reflectance distribution on the surface of the target object MT.

In the dot profile shown in FIG. 5A, since a dark portion corresponding to the dot is buried in the reflectance distribution on the surface of the target object MT, it is impossible to recognize the dot from the encode pattern image. In contrast to this, in the dot profile shown in FIG. 5B, although the profile is distorted, it is possible to properly recognize the dot from the encode pattern image. In addition, since encode pattern light is formed from only light having one wavelength, even if the target object MT has color characteristics, it is possible to properly recognize the dot from the encode pattern image as long as a dot signal higher than the noise level of the image sensor is obtained.

As described above, in this embodiment, each dot of dot pattern light as an encode pattern is formed from a bright portion, and a line pattern image and an encode pattern image are obtained separately. This makes it possible to properly recognize each dot from the encode pattern image even if there is a reflectance distribution on the surface of the target object MT. It is therefore possible to accurately measure the three-dimensional shape of the target object MT. Assume that a defocus has occurred, that is, the target object MT has shifted from the best focus position of the optical system of the projection unit 11 or the image sensing unit 12. In this case, since the dot contrast decreases, the difference in dot recognizability between this embodiment and the related art becomes more conspicuous.

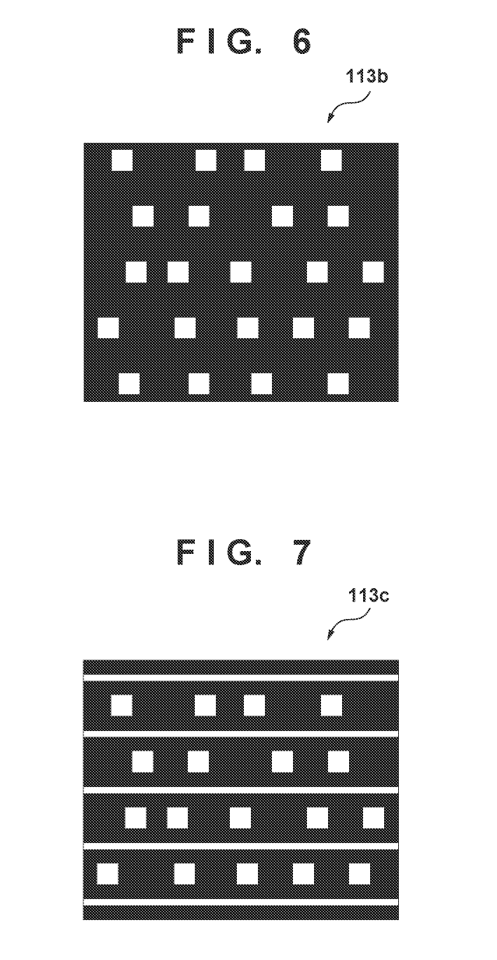

In addition, as shown in FIG. 6, the second mask 113b (its transmission portion) may be configured such that the dimension of each of a plurality of dots included in dot pattern light is larger than the width of each of a plurality of lines included in line pattern light. This can generate dot pattern light robust against the defocus of the target object MT and a reflectance distribution on the target object MT. Assume that two pattern light beams, that is, line pattern light and dot pattern light, interfere with each other on the target object MT because of image blur or the like. Even in this case, since the line pattern light and the dot pattern light are separated and sensed separately, no pattern interference occurs on an image obtained by the image sensing unit 12. This makes it possible to properly recognize each dot from an encode pattern image.

In addition, this embodiment has exemplified the case in which the two different masks, that is, the first mask 113a and the second mask 113b, are respectively used to generate line pattern light and dot pattern light. As shown in FIG. 7, however, one mask 113c using a wavelength filter may be used instead of the first mask 113a and the second mask 113b. The mask 113c includes a first transmission portion which has a shape corresponding to a plurality of lines and transmits light having the first wavelength and a second transmission portion which has a shape corresponding to a plurality of dots and transmits light having the second wavelength. In addition, a wavelength filter which transmits light having the first wavelength is arranged in the first transmission portion, and a wavelength filter which transmits light having the second wavelength is arranged in the second transmission portion. The mask 113c is illuminated with light including light having the first wavelength and light having the second wavelength through the illumination optical system. Even in consideration of image degradation caused by the defocus of the target object MT or the like, since light beams having two wavelengths (line pattern light and dot pattern light) are separated and sensed, there is no need to increase the intervals between the lines to make the dots recognizable on the mask 113c.

The measurement apparatus 1 according to this embodiment forms line pattern light and encode pattern light using light beams having different wavelengths and projects them on the target object MT. The apparatus then separates the light beams from each other and senses them, thereby obtaining a line pattern image and an encode pattern image. Therefore, the measurement apparatus 1 can properly recognize each dot from the encode pattern image. This makes it possible to improve measurement accuracy and robustness in the measurement of the three-dimensional shape of the target object MT.

### Second Embodiment

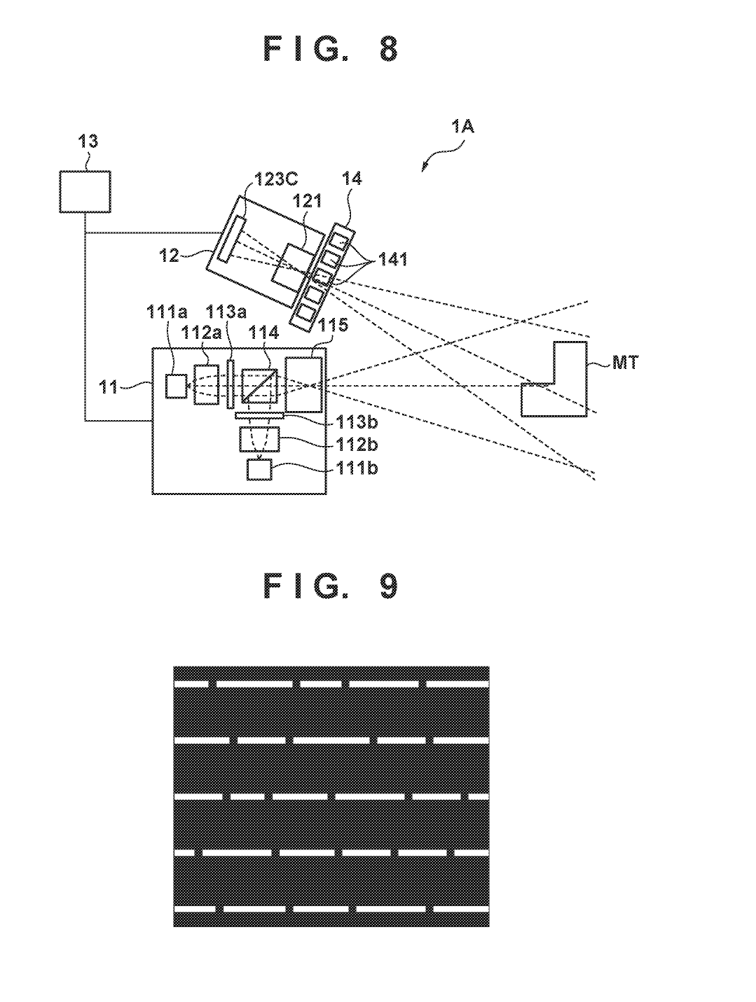

FIG. 8 is a schematic view showing the arrangement of a measurement apparatus 1A according to the second embodiment of the present invention. The measurement apparatus 1A includes an illumination unit 14 which uniformly illuminates a target object MT with light having the third wavelength different from the first and second wavelengths, in addition to a projection unit 11, an image sensing unit 12, and a processing unit 13. The measurement apparatus 1A differs from the measurement apparatus 1 in that it obtains edge data in addition to three-dimensional coordinate point group data. The measurement apparatus 1A measures the three-dimensional shape (position/posture) of the target object MT by performing model fitting using the three-dimensional coordinate point group data and the edge data. Note that model fitting is performed for a CAD model of the target object MT, which is registered in advance, based on the assumption that the three-dimensional shape of the target object MT is known in advance.

The illumination unit 14 includes a plurality of light sources 141 which emit light having the third wavelength different from the first and second wavelengths. In this embodiment, in order to implement ring illumination, the light sources 141 are arranged in a ring-like pattern. The illumination unit 14 uniformly illuminates the target object MT so as to prevent ring illumination from forming a shadow on the target object MT. However, an illumination scheme for uniformly illuminating the target object MT is not limited to ring illumination, and may be coaxial episcopic illumination, dome illumination, or the like.

In this embodiment, the image sensing unit 12 separates light having the third wavelength, with which the illumination unit 14 illuminates the target object MT, from line pattern light and dot pattern light (encode pattern light) based on the wavelengths, and senses the light having the third wavelength, thereby obtaining a brightness image (third image) corresponding to the light having the third wavelength. The image sensing unit 12 includes a color sensor 123c in place of the first image sensor 123a and the second image sensor 123b. The color sensor 123c is a sensor which obtains images by separating R, G, and B (Red, Green, and Blue) light, that is, can obtain an image of red-wavelength light, an image of green-wavelength light, and an image of blue-wavelength light. As the color sensor 123c, an RGB sensor using a Bayer color filter generally and widely used in color cameras can be used. Assume that the first, second, and third wavelengths each correspond to one of R, G, and B wavelengths of the color sensor 123c, that is, one of red, green, and blue wavelengths. Therefore, the color sensor 123c can simultaneously obtain a line pattern image corresponding to line pattern light formed from light having the first wavelength, an encode pattern image corresponding to dot pattern light formed from light having the second wavelength, and a brightness image corresponding to light having the third wavelength.

The processing unit 13 obtains information (three-dimensional coordinate point data) of the three-dimensional shape of the target object MT based on a line pattern image and an encode pattern image as in the first embodiment. In addition, in the second embodiment, the processing unit 13 obtains an edge (edge data) of the target object MT based on a brightness image. As an edge detection algorithm, one of the Canny method and other various methods can be used. The processing unit 13 uses, for example, the technique disclosed in Japanese Patent No. 5393318, and calculates the position/posture of the target object MT by performing model fitting using the three-dimensional coordinate point group data and the edge data.

The measurement apparatus 1A according to this embodiment obtains a brightness image in addition to a line pattern image and an encode pattern image. The measurement apparatus 1A can therefore accurately measure the three-dimensional shape (position/posture) of the target object MT by using three-dimensional coordinate point group data and edge data. In addition, the measurement apparatus 1A uses an RGB sensor, which has been generally and widely used, and hence can implement a low-cost pattern projection measurement apparatus having a simple arrangement.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2015-039319 filed on Feb. 27, 2015, which is hereby incorporated by reference herein in its entirety.

What is claimed is:

1. A measurement apparatus which measures a shape of a target object, the apparatus comprising:
a projection unit configured to project, on the target object, line pattern light including a plurality of lines formed from light having a first wavelength and identification pattern light formed from light having a second wavelength different from the first wavelength and including an identification pattern of a plurality of dots for respectively identifying the plurality of lines;
an image sensing unit configured to obtain a first image corresponding to the line pattern light and a second image corresponding to the identification pattern light by separating the line pattern light and the identification pattern light projected on the target object based on wavelengths and sensing the line pattern light and the identification pattern light; and
a processing unit configured to obtain information of a shape of the target object based on the first image and the second image.

2. The apparatus according to claim 1, wherein the projection unit includes
a first mask including a transmission portion which has a shape corresponding to the plurality of lines and transmits light having the first wavelength, and
a second mask including a transmission portion which has a shape corresponding to the identification pattern and transmits light having the second wavelength.

3. The apparatus according to claim 2, wherein the projection unit includes an optical element configured to combine light having the first wavelength transmitted through the transmission portion of the first mask and light having the second wavelength transmitted through the transmission portion of the second mask.

4. The apparatus according to claim 2, wherein the projection unit includes
a first illumination optical system configured to illuminate the first mask with light having the first wavelength, and
a second illumination optical system configured to illuminate the second mask with light having the second wavelength.

5. The apparatus according to claim 1, wherein the projection unit includes a mask including a first transmission portion which has a shape corresponding to the plurality of lines and transmits light having the first wavelength and a second transmission portion which has a shape corresponding to the identification pattern and transmits light having the second wavelength.

6. The apparatus according to claim 5, wherein the projection unit includes an illumination optical system configured to illuminate the mask with light including light having the first wavelength and light having the second wavelength.

7. The apparatus according to claim 1, wherein a dimension of each of the plurality of dots is larger than a width of each of the plurality of lines.

8. The apparatus according to claim 1, further comprising an illumination unit configured to uniformly illuminate the target object with light having a third wavelength different from the first wavelength and the second wavelength,
wherein the image sensing unit obtains a third image corresponding to the light having the third wavelength by separating the light having the third wavelength from the line pattern light and the identification pattern light based on wavelengths and sensing the light having the third wavelength, and
the processing unit obtains an edge of the target object based on the third image.

9. The apparatus according to claim 8, wherein the image sensing unit includes a color sensor configured to obtain an image of red-wavelength light, an image of green-wavelength light, and an image of blue-wavelength light, and
each of the first wavelength, the second wavelength, and the third wavelength corresponds to any one of the red wavelength, the green wavelength, and the blue wavelength.

10. The apparatus according to claim 1, wherein the image sensing unit includes
an optical element configured to separate the line pattern light and the identification pattern light based on wavelengths,
a first image sensor configured to sense the line pattern light separated by the optical element, and
a second image sensor configured to sense the identification pattern light separated by the optical element.

11. A measurement apparatus which projects pattern light on a target object and senses the pattern light projected on the target object, the apparatus comprising:
a projection unit configured to project, on the target object, line pattern light including a plurality of lines formed from light having a first wavelength and identification pattern light formed from light having a second wavelength different from the first wavelength and including an identification pattern of a plurality of dots for respectively identifying the plurality of lines; and
an image sensing unit configured to obtain a first image corresponding to the line pattern light and a second image corresponding to the identification pattern light by separating the line pattern light and the identification pattern light projected on the target object based on wavelengths and sensing the line pattern light and the identification pattern light.
